(19) United States
(12) Patent Application Publication
(10) Pub. No.: US 2012/0030001 A1
(43) Pub. Date: Feb. 2, 2012

(54) RELAY DEVICE, CONTROL METHOD FOR A RELAY DEVICE, AND CONTROL METHOD FOR A COUPON ISSUING SYSTEM

(75) Inventor: Chiharu Takeuchi, Azumino-shi (JP)

(73) Assignee: SEIKO EPSON CORPORATION, Shinjuku-ku (JP)

(21) Appl. No.: 13/193,504

(22) Filed: Jul. 28, 2011

(30) Foreign Application Priority Data
Jul. 30, 2010 (JP) 2010-171995

(51) Int. Cl. G06Q 30/00

(52) U.S. Cl. 705/14.35

(57) ABSTRACT

A relay device, expansion board, coupon issuing system, control method for a relay device, and a program enable adding a coupon issuing function at a low cost. A coupon-issuing control unit that generates and outputs coupon print data corresponding to receipt print data to a printer provides a relay device that has an expiration information acquisition unit that acquires expiration information corresponding to a product code, a coupon-issuing period calculation unit that calculates a coupon-issuing period from the expiration information, a coupon print data generating unit that generates coupon print data when the current date and time is in the coupon-issuing period, and a coupon print data output unit that outputs coupon print data to the printer.

Priority is claimed under 35 U.S.C. §119 to Japanese Application No. 2010-171995 filed on Jul. 30, 2010, which is hereby incorporated by reference in its entirety.

### BACKGROUND

1. Technical Field

The present invention relates to a relay device that is used connected to an input device, printing device, and POS terminal, to a control method for the relay device, and to a control method for a coupon issuing system.

2. Related Art

One example of this type of system is the sales promotion system that runs a lottery process and selectively issues coupons when membership is verified by a coupon printing terminal (a multimedia kiosk) connected to a POS register and POS server as taught in Japanese Unexamined Patent Appl. Pub. JP-A-2007-011852. The POS server in this sales promotion system generates coupon lottery information when the most recent anticipated sales count for a product is less than a preset scheduled sales count. The coupon lottery information is then sent to the coupon printing terminal, and a coupon is issued. Selling a particular product can thus be promoted when sales of the product are worse than expected.

With the sales promotion system described in JP-A-2007-011852 the POS server generates coupon lottery information for issuing coupons, and a terminal that is connected to the POS register and POS server and is dedicated to printing coupons issues the coupons. More specifically, a terminal dedicated to printing coupons must be added and the POS server must be modified in order to add a coupon printing function to the POS system when none of the devices used in the system have a function for printing coupons. The cost of adding a coupon issuing function to an existing system is therefore great.

### SUMMARY

A relay device, a control method for a relay device, and a coupon issuing system according to the present invention reduce the cost of adding a coupon issuing function.

A first aspect of the invention is a relay device that is used connected to an input device, a printing device, and a POS terminal, the relay device including: a receipt-issuing control unit that outputs a product code acquired from the input device to the POS terminal, acquires receipt print data corresponding to the product code from the POS terminal, and outputs the receipt print data to the printing device; a clock unit that keeps the current date and time; and a coupon-issuing control unit that generates coupon print data corresponding to the receipt print data, outputs the coupon print data to the printing device. The coupon-issuing control unit includes an expiration information acquisition unit that acquires from the input device expiration information corresponding to the product code acquired from the input device, a coupon-issuing period calculation unit that calculates a coupon-issuing period from the acquired expiration information, a coupon print data generating unit that generates the coupon print data when the current date and time kept by the clock unit is within the coupon-issuing period, and a coupon print data output unit that outputs the generated coupon print data to the printing device.

Another aspect of the invention is a control method for a relay device that includes an expiration information acquisition step that acquires from the input device expiration information corresponding to the product code acquired from the input device; a coupon-issuing period calculation step that calculates a coupon-issuing period from the acquired expiration information; a coupon print data generating step that generates the coupon print data when the current date and time kept by the clock unit is within the coupon-issuing period; and a coupon print data output step that outputs the generated coupon print data to the printing device.

A control method for a coupon issuing system according to another aspect of the invention includes an expiration information acquisition step that acquires from the input device expiration information corresponding to the product code acquired from the input device; a coupon-issuing period calculation step that calculates a coupon-issuing period from the acquired expiration information; a coupon print data generating step that generates the coupon print data when the current date and time kept by the clock unit is within the coupon-issuing period; and a coupon print data output step that outputs the generated coupon print data to the printing device.

In these aspects of the invention, a relay device that communicates with an input device, printing device (that is, a POS peripheral), and POS terminal has a coupon printing capability, and therefore enables rendering a coupon printing function in a POS system by simply adding the relay device without changing the POS terminal or other devices. More specifically, the cost of introducing a coupon printing function can be suppressed.

In addition, sales of products that are close to the sell-by date can be promoted if the coupon-issuing period is predefined as a specified time until the expiration date. In addition, because coupons are issued in the process of issuing a sales receipt for a product, the return-customer rate can be improved by making the content of the coupon usable on the next purchase. In addition, if customers are made aware that coupons are issued for products that are near the expiration date, there is no need for employees to relabel products or change the price displayed in the store.

Preferably, the coupon-issuing period calculation unit calculates a product selling limit from the expiration information, sets the coupon-issuing period before and including the product selling limit as a first coupon-issuing period, and sets the coupon-issuing period after the product selling limit as a second coupon-issuing period; and the coupon print data generating unit generates coupon print data with different content when the current date and time is in the first coupon-issuing period and when the current date and time is in the second coupon-issuing period.

In addition to issuing coupons for products approaching the sell-by date in the first coupon-issuing period, this aspect of the invention also issues coupons of greater value in the second coupon-issuing period than the coupons issued in the first coupon-issuing period. For example, a coupon can be printed and given instead of the product to the customer when a customer tries to purchase a product that is already passed the sell-by date but has not been removed from the shelves, for example. Note that the relay device preferably sends an error code to the POS terminal in the second coupon-issuing period.

Further preferably, the coupon print data is data for printing a coupon that can be used in a future sale transaction.

This aspect of the invention can improve the return customer rate by issuing coupons.

Further preferably, the coupon print data output unit outputs coupon print data corresponding to the receipt print data added to the receipt print data.

This aspect of the invention can issue receipts on which coupon information is also printed. Forgetting to give a coupon to the customer can therefore be prevented, and coupons can be reliably presented to customers. In addition, because the coupon information is printed on the receipt, there is no need to hand the receipt and a separate coupon to the customer, and the employee's job can be made easier.

Further preferably, the coupon print data output unit outputs expiration information corresponding to the receipt print data added to the receipt print data.

Further preferably, the printing device includes a receipt printer that prints receipts based on the receipt print data, and a coupon printer that prints coupons based on the coupon print data; and the coupon print data output unit outputs the coupon print data to the coupon printer.

This aspect of the invention enables printing receipts and coupons from different printers. As a result, the likelihood of the customer accidentally discarding the coupon with the receipt is lower than when the receipt and coupon are printed together, and coupons can be reliably given to customers. In addition, coupons can be printed on a different print medium than receipts, such as on thicker paper or on color paper.

Further preferably, the input device includes a product code input device that inputs product codes, and an expiration information input device that inputs expiration information; and the expiration information acquisition unit acquires from the expiration information input device expiration information corresponding to the product code input from the product code input device.

When expiration information is not contained in the product information included on the product label applied to the product, for example, this aspect of the invention enables acquiring the expiration information from the expiration information input device. A coupon issuing function can therefore be rendered even in a POS system that does not have a product expiration management function.

In another aspect of the invention, the relay device is used installed in a printing device.

This aspect of the invention affords a coupon issuing system that reduces the amount of space needed around the printing device.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a block diagram showing the configuration of a coupon issuing system according to a first embodiment of the invention.

FIG. 2 describes the coupon issuing period.

FIG. 3 is a flow chart of the coupon issuing process executed by an expansion board.

FIG. 4 shows an example of a coupon issued in the first coupon issuing period.

FIG. 5 shows an example of a coupon issued in the second coupon issuing period.

FIG. 6 is a block diagram showing the configuration of a coupon issuing system according to a variation of the first embodiment.

FIG. 7 is a block diagram showing the configuration of a coupon issuing system according to a second embodiment of the invention.

### DESCRIPTION OF EMBODIMENTS

Preferred embodiments of a relay device and coupon issuing system according to the present invention are described below with reference to the accompanying figures. The following embodiments describe the relay device of the invention embodied in an expansion board that is installed in a receipt printer. The following embodiments also describe a coupon issuing system used in a store that sells products including food products with an expiration date or best-used-by date.

### Embodiment 1

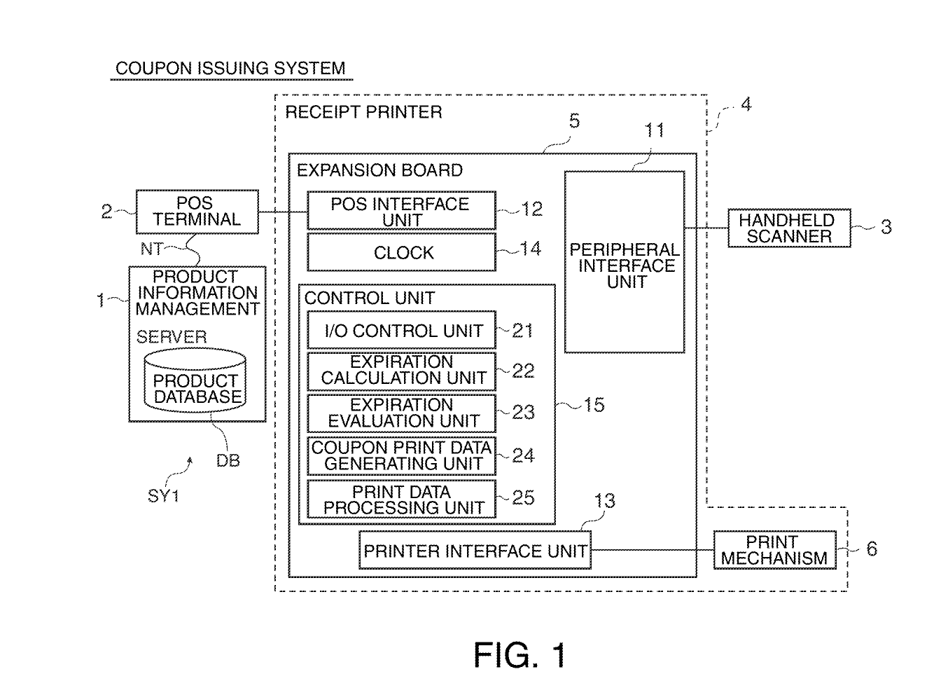

FIG. 1 is a block diagram showing the configuration of a coupon issuing system SY1 according to a first embodiment of the invention. As shown in the figure, the coupon issuing system SY1 includes a product information management server 1, a POS terminal 2, a handheld scanner 3 (input device) for inputting product information, a receipt printer 4 (printing device) that prints receipts, and an expansion board 5 (relay device) installed in the receipt printer 4.

In this embodiment of the invention the product information includes a product code and expiration information, which may denote the best-used-by date or the expiration date of the product, for example.

A product expiration management function and a coupon issuing function are embodied in the expansion board 5 installed in the receipt printer 4 in the coupon issuing system SY1 of the invention.

The product information management server 1 and POS terminal 2 are connected by means of a network NT such as an intranet or the Internet. The POS terminal 2 and the expansion board 5 installed in the receipt printer 4, and the expansion board 5 and the handheld scanner 3, are connected through independent interfaces (such as a USB (Universal Serial Bus)) interface. The POS terminal 2 and expansion board 5 may be connected by wire or wirelessly.

The product information management server 1 is typically located in the back-office operations center of the store, for example, and stores a product database DB. The product database DB is used to manage basic information about all products such as the product code, product name, product price, and manufacturer.

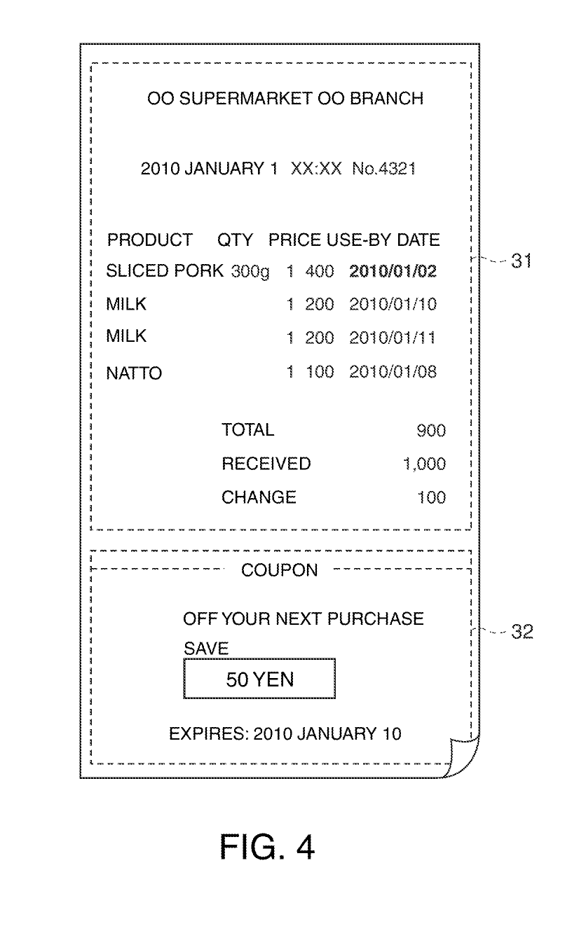

When the POS terminal 2 acquires the product code contained in the product information input by the handheld scanner 3 through the expansion board 5, it queries the product database DB on the product information management server 1 and generates receipt print data based on the product code. The receipt print data includes product-related information (such as the product name, quantity, and price), transaction information, receipt issuing information, and store information (FIG. 4). The POS terminal 2 outputs the generated receipt print data to the expansion board 5.

The receipt printer 4 includes the removably installed expansion board 5, and the print mechanism 6 for printing.

The expansion board 5 includes a peripheral interface unit 11 (expiration information acquisition unit) for inputting product information from the handheld scanner 3, a POS interface unit 12 that outputs product codes to the POS terminal 2 and acquires receipt print data, a printer interface unit 13 that outputs the receipt print data to the print mechanism 6, a clock 14, and a control unit 15.

The clock 14 is a real-time clock that keeps the current date and time. In this embodiment of the invention the current date and time are read by the expiration evaluation unit 23 of the control unit 15.

The control unit 15 includes an I/O (input/output) control unit 21, expiration calculation unit 22 (coupon issuing period calculation unit), expiration evaluation unit 23, coupon print data generating unit 24, and print data processing unit 25.

The I/O control unit 21 controls data input and output with peripheral devices (the handheld scanner 3 and print mechanism 6). More specifically, the I/O control unit 21 controls acquiring product information from the handheld scanner 3, controls extracting and outputting the product code from the product information to the POS terminal 2, controls acquiring the receipt print data generated by the POS terminal 2 for the product code, and controls outputting the receipt print data to the print mechanism 6. Based on the decision supplied from the expiration evaluation unit 23 described below, the I/O control unit 21 also controls sending an error code to the POS terminal 2 instead of sending the product code when the sell-by date (last sale date) of the product has already passed. Note that a receipt-issuing control unit in the accompanying claims points mainly to this I/O control unit 21.

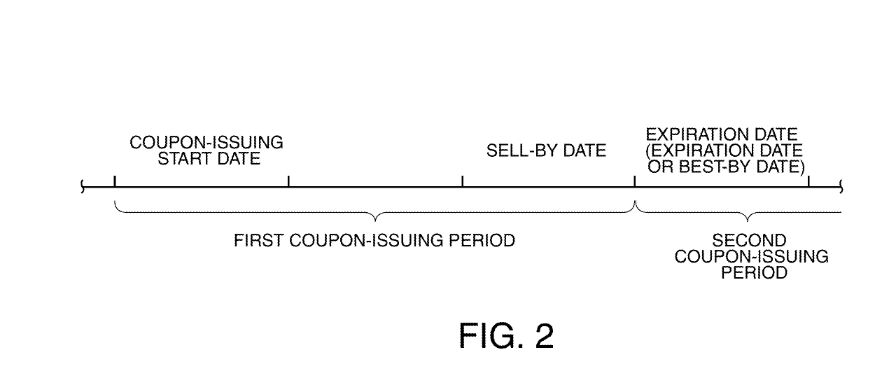

The expiration calculation unit 22 reads the use-by date of the product from the expiration information contained in the acquired product information, and calculates the sell-by date and the coupon-issuing period of the product from the use-by date. The product use-by date, sell-by date, and coupon-issuing period are described next with reference to FIG. 2. Each index in the figure represents one day. In this embodiment of the invention the use-by date represents the expiration date or best-used-by date of the product, and the day before the use-by date is the sell-by date. Two days before the sell-by date is the coupon-issuing start date. The period from the coupon-issuing start date to the sell-by date is a first coupon-issuing period, and the period including and following the day after the sell-by date (that is, the use-by date) is a second coupon-issuing period.

The expiration calculation unit 22 calculates the sell-by date by subtracting a specific number of days (one day in this embodiment of the invention) from the use-by date, and subtracts a specific number of days (two days in this embodiment of the invention) from the calculated sell-by date to compute the coupon-issuing start date. The period from the coupon-issuing start date to the sell-by date is calculated as the first coupon-issuing period, and the period from the day after the sell-by date is calculated as the second coupon-issuing period.

The specific numbers of days used for these calculations are stored in a storage unit not shown. In addition, the specific numbers of days are determined by the manufacturer or store, for example, and different numbers of days may be specified according to the characteristics of individual products.

Further alternatively, the use-by limit of a product may specify a use-by date and time instead of just a date. More specifically, the expiration information may include information denoting a time of day in addition to the date. In this case, however, a “specified time” is defined for calculating the sell-by limit.

The expiration evaluation unit 23 determines if the current date and time is outside the coupon-issuing period or is in the first coupon-issuing period or second coupon-issuing period. Based on this decision, the control unit 15 determines whether or not to generate coupon print data, and whether or not the product can be sold. This is described in detail below.

If the current date and time is in the coupon-issuing period, the coupon print data generating unit 24 generates coupon print data.

If the current date and time is in the first coupon-issuing period, the coupon print data generating unit 24 generates first coupon print data, and generates second coupon print data if the current date and time is in the second coupon-issuing period.

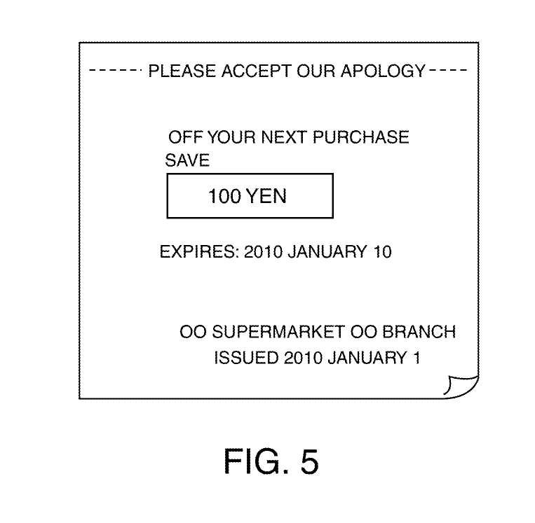

The first coupon print data is for issuing a coupon that is printed on the receipt as shown in FIG. 4 for products that are between the coupon-issuing start date and the sell-by date. The second coupon print data is for issuing a separate coupon as shown in FIG. 5 as an expression of apology to a customer for products that are passed the sell-by date and cannot be sold.

The print data processing unit 25 runs a process that adds expiration information and coupon print data to the receipt print data generated by the POS terminal 2. In this process of adding expiration information, the print data processing unit 25 links expiration information for a product to the product name contained in the receipt print data. More specifically, the print data processing unit 25 queries a previously stored product name table, which correlates product names and product codes, to find the product information (product code and expiration information) that was acquired from the handheld scanner 3 and temporarily stored in a storage unit, and correlates the expiration information to the product names contained in the receipt print data. Note that product codes are not contained in the receipt print data in this embodiment of the invention.

The product name table may be previously downloaded from the product information management server 1 or from a separate medium such as a CD-ROM disc on which the product name table is stored. Further alternatively, if product names and product codes are contained in the receipt print data, the product names and product codes that are contained in the print data could be stored and accumulated in a local database each time receipt print data is acquired from the POS terminal 2.

If information related to plural products with the same product name is contained in the receipt print data, and the expiration information is different for some of the products with the same product name, the print data processing unit 25 may sort and print the information for the plural products by their respective use-by dates. If the current date and time is the day before or two days before the use-by date, the use-by date could also be printed with emphasis.

The process of adding coupon print data executed by the print data processing unit 25 when the current date and time is in the first coupon-issuing period adds the first coupon print data that was generated to the receipt print data produced by the POS terminal 2. However, because the POS terminal 2 does not produce receipt print data if the current date and time is in the second coupon-issuing period, the print data processing unit 25 outputs the coupon print data as the print data. If the current date and time is outside the coupon-issuing period, the print data processing unit 25 outputs the receipt print data without adding coupon print data.

A coupon-issuing control unit as used herein includes particularly the expiration calculation unit 22, expiration evaluation unit 23, coupon print data generating unit 24, and print data processing unit 25.

A coupon print data output unit includes the print data processing unit 25 and printer interface unit 13.

The print mechanism 6 acquires print data processed by the print data processing unit 25, and outputs receipts and coupons.

The handheld scanner 3 scans and inputs the product information, which is a barcode that is printed or applied on the product. The product information can also be input by an employee manually entering product information composed of a numeric string from a keyboard (not shown in the figure) connected to the POS terminal 2. The keyboard is also used for inputting product quantities and the amount received from the customer.

The coupon issuing system SY1 according to this embodiment of the invention also has a display device (not shown in the figure) connected to the POS terminal 2 to display a transaction process screen during a transaction process. The employee runs a transaction process while checking the transaction process screen shown on the display device. If a product processed in the transaction has already passed the sell-by date, the display device displays receives an error code and displays an error message, for example. A separate display device such as a customer display may also be connected to a peripheral device or the print mechanism 6 to display the transaction process screen and warning messages when the sell-by date of a product has already passed, or display a message informing the customer when a coupon is issued. In this case the expansion board 5 outputs the receipt print data and the display data to separate display devices.

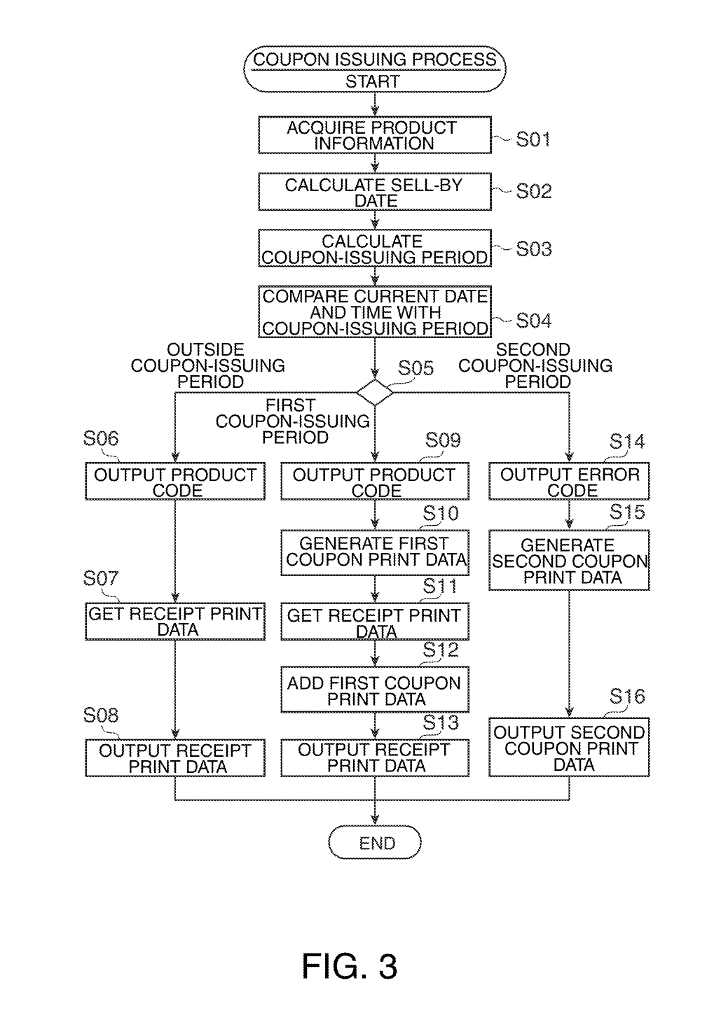

The coupon-issuing process of the expansion board 5 (relay device) is described next with reference to FIG. 3.

When product information is received from the handheld scanner 3 (S01), the expansion board 5 (control unit 15) calculates the sell-by date of the product from the expiration information contained in the product information (S02), and calculates the coupon-issuing period from the calculated sell-by date (S03). The expansion board 5 (control unit 15) then compares the calculated coupon-issuing period with the current date and time (S04). If the current date and time is determined to be outside the coupon-issuing period (S05: outside coupon-issuing period), the expansion board 5 extracts and outputs the product code contained in the acquired product information to the POS terminal 2 (S06). When the receipt print data is then acquired from the POS terminal 2 (S07), the expansion board 5 outputs the product expiration information correlated to the receipt print data to the print mechanism 6 (S08).

If the current date and time is in the first coupon-issuing period (505: first coupon-issuing period), the expansion board 5 extracts and outputs the product code contained in the acquired product information to the POS terminal 2 (S09). The control unit 15 then generates first coupon print data (S 10). The expansion board 5 then acquires the receipt print data from the POS terminal 2 (S11), links the product expiration information to the receipt print data, adds the first coupon print data (S 12), and outputs to the print mechanism 6 (S13).

If the current date and time is determined to be in the second coupon-issuing period (505: second coupon-issuing period), the expansion board 5 outputs an error code instead of the acquired product code to the POS terminal 2 (S14). The control unit 15 then generates second coupon print data (S15). The POS terminal 2 does not generate receipt print data for a product that is passed the sell-by date when an error code is received because the product information cannot be read from the error code. As a result, the expansion board 5 outputs the second coupon print data as the print data to the print mechanism 6 (S16). Note that an error code is a non-existent product code that the POS terminal 2 recognizes as an error. When an error code is received, the POS terminal 2 reports an error by driving an LED or electronic buzzer, for example.

A case in which receipt print data for one product is generated is described above, but in practice plural products are commonly included in the receipt print data. Coupon print data is preferably generated in this case if the products included in the receipt print data for one receipt include one or more products for which a coupon is to be issued. More specifically, if the products contained in the receipt print data for one receipt include at least one product for which the current date and time is within the coupon-issuing period, the first coupon print data is added to the receipt print data even if the other products are outside the coupon-issuing period.

In addition, if the group of products contained in one receipt include a product in the second coupon-issuing period based on the product name and expiration information linked by the print data processing unit 25, the second coupon print data may be added to the receipt print data, or the second coupon print data may be printed separately from the receipt.

Furthermore, the first coupon print data and the second coupon print data may both be added to the receipt print data for one receipt.

Further alternatively, if the receipt print data for one receipt includes plural products for which coupons are issued, a coupon could be issued for each product or one coupon could be issued per receipt. In this case, whether or not the current date and time is in the coupon-issuing period of each product could be determined for each product until the receipt print data is acquired from the POS terminal 2, and the coupon print data could be generated when the receipt print data is acquired.

The issued coupons are described below with reference to FIG. 4 and FIG. 5.

FIG. 4 shows an example of a receipt to which a coupon is added when the current date and time is in the first coupon-issuing period. This receipt has a receipt portion 31 and a coupon portion 32. The store name (which may be a store logo), the date and time the receipt is printed, the number of the receipt, product-related information (such as the product name, quantity, and price), the expiration information (the expiration date or use-by date), and transaction information (total amount, amount received, change due) are printed in the receipt portion 31. Discount information and the expiration date of the coupon are printed in the coupon portion 32. The current date and time is determined to be within the first coupon-issuing period and a receipt is issued in this case because the sell-by date (the day before the expiration date) of the sliced pork included in the list of purchased products is the same as the current date and time (the date the receipt is printed). First coupon print data is therefore generated and printed in the coupon portion 32, and can be used on a future visit to the store to receive a discount on a future purchase.

By printing the coupon added to the receipt, forgetting to hand the coupon to the customer is prevented, coupons can be reliably given to customers, there is no need to hand the receipt and a separate coupon to the customer, and the employee's job is made easier. Sales of products that are close to the sell-by date can also be promoted by defining a first coupon-issuing period. In addition, because the coupon can be used on a future purchase, the return-customer rate can be improved. Convenience is also improved if customers are previously made aware of the coupon-issuing start date because there is no need for employees to relabel products or change the set price in the store.

FIG. 5 shows an example of a coupon that is issued when the current date and time is in the second coupon-issuing period. In addition to the coupon (discount) amount and expiration date, the store name and the date the coupon was issued are also printed on the coupon based on the second coupon print data that was generated. A title indicating that the coupon is an apology coupon is also printed because the coupon is being issued because a product is passed the sell-by date and cannot be sold.

By thus issuing a coupon of greater value in the second coupon-issuing period than coupons issued in the first coupon-issuing period, a coupon can be printed and given instead of the product to the customer when a customer tries to purchase a product that is already passed the sell-by date but has not been removed from the shelves, for example.

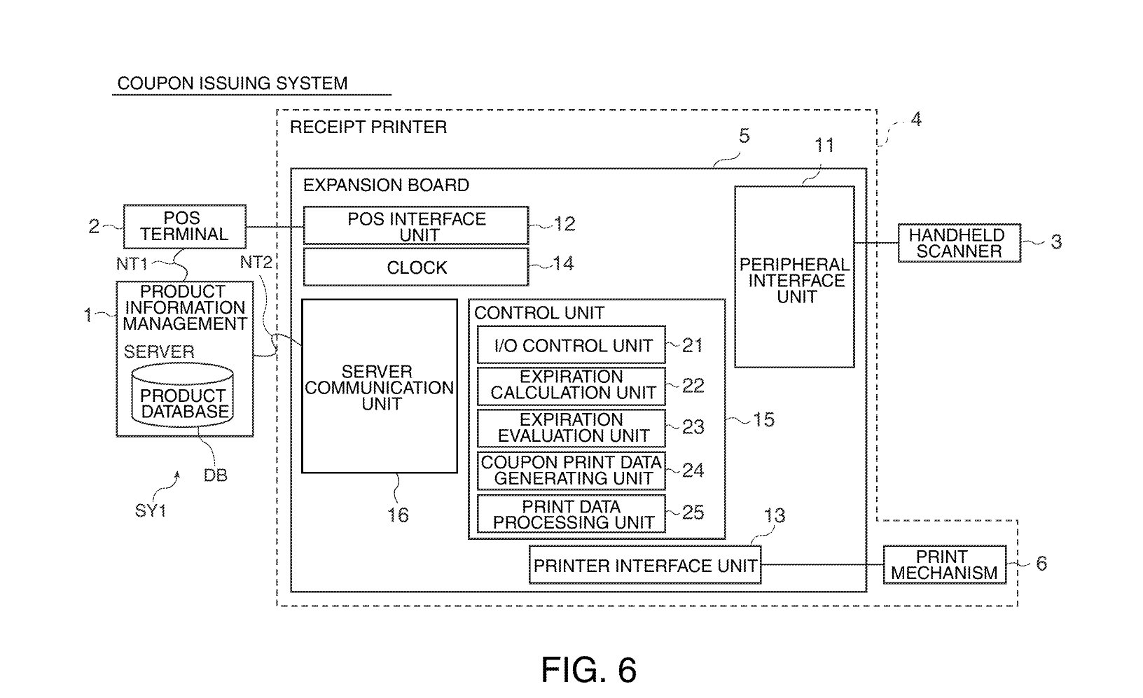

If product expiration information is not contained in the product information acquired from the handheld scanner 3 (product code input device) but the product expiration information is stored in the product database DB managed by the product information management server 1 (expiration information input device) of the coupon issuing system SY1, the expansion board 5 could acquire the expiration information from the product information management server 1 and handle managing product expiration and issuing coupons as shown in FIG. 6.

More specifically, the product information management server 1 and expansion board 5 are connected in this configuration by a network NT2 such as an intranet or the Internet as shown in the figure, and the expansion board 5 has a server communication unit 16 (expiration information acquisition unit) that acquires expiration information from the product information management server 1. When the expansion board 5 (control unit 15) in this configuration gets the product code for a product from the handheld scanner 3, it also gets the expiration information for that product from the product information management server 1 by means of the server communication unit 16.

This embodiment of the invention thus enables adding a coupon issuing function to the system even when an expiration management function is not provided in the POS terminal 2, and product expiration information is also not contained in the product information applied to each product. Alternatively, product expiration information could be previously downloaded from the product information management server 1 instead of being acquired from the product information management server 1 each time a product code is acquired. Further alternatively, product expiration information could be downloaded from a separate storage medium such as CD-ROM.

### Embodiment 2

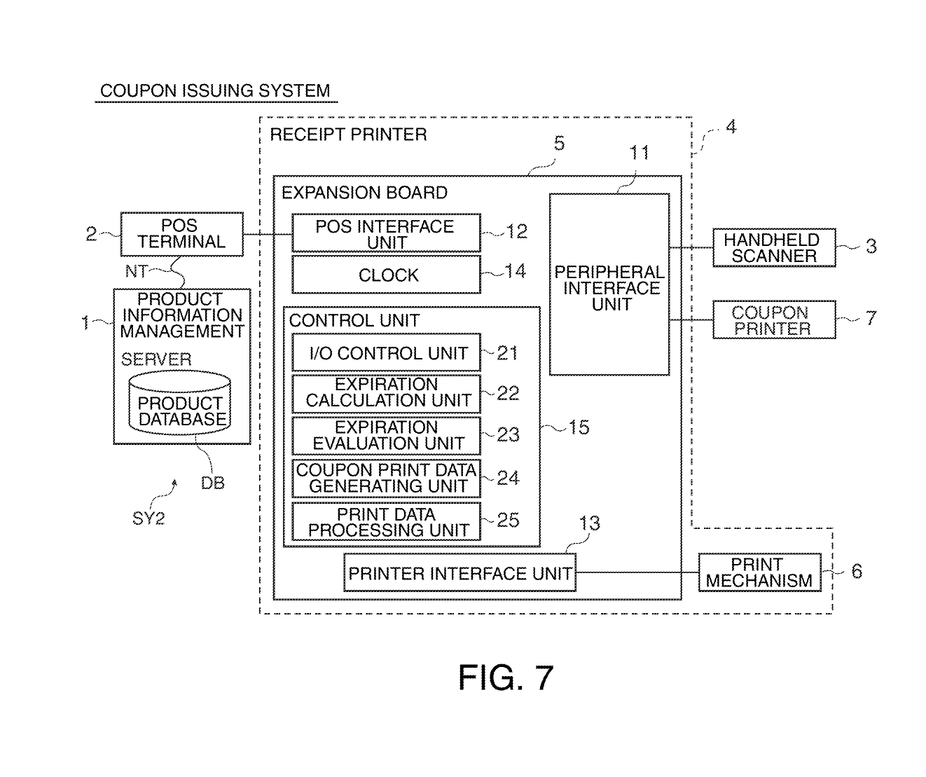

A second embodiment of the invention is described next with reference to FIG. 7. Note that like parts in this and the first embodiment are identified by like reference numerals, and further detailed description thereof is omitted below. Variations applicable to the first embodiment are also applicable to this embodiment.

The coupon issuing system SY2 according to this embodiment of the invention adds a coupon printer 7 (coupon printing device) to the coupon issuing system SY1 described above.

The coupon printer 7 is connected to the expansion board 5 through a USB (Universal Serial Bus) interface, for example. In this embodiment of the invention the expansion board 5 outputs the receipt print data acquired from the POS terminal 2 to the print mechanism 6 (receipt printer), and outputs the generated coupon print data (first coupon print data and second coupon print data) to the coupon printer 7. The print medium used in the coupon printer 7 may use thicker paper, color paper, or other medium different from the medium used to print receipts.

This second embodiment of the invention enables printing receipts and coupons from different printers. Compared with when receipts and coupons are printed together, this embodiment reduces the chances that the customer receiving the coupon will accidentally throw the coupon away with the receipt, and can reliably supply receipts to customers.

In the coupon issuing systems SY1, SY2 described above, a relay device that communicates with an input device, printing device (that is, a POS peripheral), and POS terminal by means of the expansion board 5 has a coupon printing capability, and therefore enables rendering a coupon printing function in a POS system by simply adding the relay device without changing the POS terminal or other devices. More specifically, the cost of introducing a coupon printing function can be suppressed.

The foregoing embodiments describe installing the expansion board 5 in the receipt printer 4, but the expansion board 5 can be installed in a peripheral other than the receipt printer 4, such as the handheld scanner 3 or display device. Further alternatively, the expansion board 5 could be installed in the POS terminal 2, or the function of the expansion board 5 could be rendered in the POS terminal 2. The expansion board 5 may also be rendered as a separate relay device.

Furthermore, while the products considered in the foregoing embodiments are foods, and the use-by date is the best-if-used-by date or expiration date of the product, the invention can also be used with non-food products, such as drugs and cosmetics, that have an expiration date or use-by date, for example.

The steps of the processes executed by the coupon issuing systems SY1, SY2 can also be embodied as a computer-executable program. This program can be stored and supplied on a recording medium such as a CD-ROM or flash memory, for example. More specifically, a program that causes a computer to function as the components of the coupon issuing systems SY1, SY2 described above, and a recording medium storing this program, are also included in the scope of the accompanying claims.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. A relay device that is used connected to an input device, a printing device, and a POS terminal, comprising:
a receipt-issuing control unit that outputs a product code acquired from the input device to the POS terminal, acquires receipt print data corresponding to the product code from the POS terminal, and outputs the receipt print data to the printing device;
a clock unit that keeps the current date and time; and
a coupon-issuing control unit that generates coupon print data corresponding to the receipt print data, outputs the coupon print data to the printing device, and includes
an expiration information acquisition unit that acquires from the input device expiration information corresponding to the product code acquired from the input device,
a coupon-issuing period calculation unit that calculates a coupon-issuing period from the acquired expiration information,
a coupon print data generating unit that generates the coupon print data when the current date and time kept by the clock unit is within the coupon-issuing period, and
a coupon print data output unit that outputs the generated coupon print data to the printing device.

2. The relay device described in claim 1, wherein:
the coupon-issuing period calculation unit calculates a product selling limit from the expiration information, sets the coupon-issuing period before and including the product selling limit as a first coupon-issuing period, and sets the coupon-issuing period after the product selling limit as a second coupon-issuing period; and
the coupon print data generating unit generates coupon print data with different content when the current date and time is in the first coupon-issuing period and when the current date and time is in the second coupon-issuing period.

3. The relay device described in claim 1, wherein:
coupon print data is data for printing a coupon that can be used in a future sale transaction.

4. The relay device described in claim 1, wherein:
the coupon print data output unit outputs coupon print data corresponding to the receipt print data added to the receipt print data.

5. The relay device described in claim 4, wherein:
the coupon print data output unit outputs expiration information corresponding to the receipt print data added to the receipt print data.

6. The relay device described in claim 1, wherein:
the printing device includes a receipt printer that prints receipts based on the receipt print data, and a coupon printer that prints coupons based on the coupon print data; and
the coupon print data output unit outputs the coupon print data to the coupon printer.

7. The relay device described in claim 1, wherein:
the input device includes a product code input device that inputs product codes, and an expiration information input device that inputs expiration information; and
the expiration information acquisition unit acquires from the expiration information input device expiration information corresponding to the product code input from the product code input device.

8. The relay device described in claim 1, wherein:
the relay device is used installed in a printing device.

9. A control method for a relay device that is used connected to an input device, a printing device, and a POS terminal, and has
a receipt-issuing control unit that outputs a product code acquired from the input device to the POS terminal, acquires receipt print data corresponding to the product code from the POS terminal, and outputs the receipt print data to the printing device,
a clock unit that keeps the current date and time, and
a coupon-issuing control unit that generates coupon print data corresponding to the receipt print data, outputs the coupon print data to the printing device,
the control method comprising as steps executed by the coupon-issuing control unit:
an expiration information acquisition step that acquires from the input device expiration information corresponding to the product code acquired from the input device;
a coupon-issuing period calculation step that calculates a coupon-issuing period from the acquired expiration information;
a coupon print data generating step that generates the coupon print data when the current date and time kept by the clock unit is within the coupon-issuing period; and
a coupon print data output step that outputs the generated coupon print data to the printing device.

10. The control method for a relay device described in claim 9, wherein:
the coupon-issuing period calculation step includes a step of calculating a product selling limit from the expiration information, setting the coupon-issuing period before and including the product selling limit as a first coupon-issuing period, and setting the coupon-issuing period after the product selling limit as a second coupon-issuing period; and
the coupon print data generating step includes a step of generating coupon print data with different content when the current date and time is in the first coupon-issuing period and when the current date and time is in the second coupon-issuing period.

11. A control method of a coupon issuing system including an input device, a printing device, and a POS terminal, comprising:
an expiration information acquisition step that acquires from the input device expiration information corresponding to the product code acquired from the input device;
a coupon-issuing period calculation step that calculates a coupon-issuing period from the acquired expiration information;
a coupon print data generating step that generates the coupon print data when the current date and time kept by the clock unit is within the coupon-issuing period; and
a coupon print data output step that outputs the generated coupon print data to the printing device.

12. The control method for a coupon issuing system described in claim 11, wherein:
the coupon-issuing period calculation step includes a step of calculating a product selling limit from the expiration information, setting the coupon-issuing period before and including the product selling limit as a first coupon-issuing period, and setting the coupon-issuing period after the product selling limit as a second coupon-issuing period; and
the coupon print data generating step includes a step of generating coupon print data with different content when the current date and time is in the first coupon-issuing period and when the current date and time is in the second coupon-issuing period.
